(19) United States
(12) Patent Application Publication
(10) Pub. No.: US 2017/0057873 A1
(43) Pub. Date: Mar. 2, 2017

(54) DRY MORTAR, MORTAR SLURRY AND METHOD FOR PRODUCING SEMI-RIGID COATINGS

(71) Applicant: HeidelbergCement AG, Heidelberg (DE)

(72) Inventors: Kai WORTMANN, Neckargemuend (DE); Frank OBST, Hockenheim (DE); Eckhard WAGNER, Heidelberg (DE); Stefan SCHOENE, Heidelberg (DE)

(73) Assignee: HEIDELBERGCEMENT AG, Heidelberg (DE)

(21) Appl. No.: 15/120,201

(22) PCT Filed: Feb. 20, 2015
(86) PCT No.: PCT/EP2015/000391

§ 371 Date: Aug. 19, 2016

(30) Foreign Application Priority Data
Feb. 22, 2014 (EP) 14000628.9

(51) Int. Cl. C04B 28/04; C04B 24/04; C04B 24/34; E01C 7/26; C04B 22/06; C04B 24/38; C04B 40/06; C04B 14/26; C04B 22/00

(52) U.S. Cl. CPC C04B 28/04; C04B 14/26; C04B 24/04; C04B 24/34; C04B 22/0093; C04B 22/06; C04B 24/383; C04B 40/0608; E01C 7/26; E01C 7/265; C04B 2111/1056

(57) ABSTRACT

The present invention relates to a dry mortar and a mortar slurry as well as a method for producing semi-rigid coatings. In one embodiment, the dry mortar or the mortar slurry contains a cement, a very fine component and a plasticizer and is free from silica fume, wherein the mortar slurry can be applied at a temperature of the asphalt support structure of 55 to 80° C. and a compressive strength of at least 100 N/mm² is achieved after 28 days. In a further embodiment, the dry mortar or the mortar slurry also contains a gelling agent such that the mortar slurry has a reduced efflux tendency.

The present invention relates to a dry mortar and a mortar slurry thereof as well as a method for producting semi-rigid coatings.

A semi-rigid top layer or a semi-rigid coating is understood to be a mortared, bitumen-bound floor coating. The semi-rigid coating consists of a bitumen-bound support structure, in short asphalt support structure, the void content of which is typically in the range from 10 to 40% by volume and which is filled with a low-viscosity, high strength (≧100 N/mm² after 28 d) mortar.

When implemented correctly, the coating combines the flexibility of asphalt with the strength of concrete. The binder is shrinkage compensated and fast setting. Due to the fast strength development, the semi-rigid coating can be used after just 12 to 24 hours depending on the temperature (at approx. 20° C.). The compressive strength of the finished coating is approx. 10 N/mm². An advantage of the semi-rigid coating is that it can be implemented without joints.

The semi-rigid coating is mostly used for high loads, where conventional asphalt is not sufficient or where the joints in concrete are problematic. It is suitable for long-lasting loads and for areas of application with considerable temperature fluctuations. Furthermore, it has a very dense surface and is therefore resistant against frost and de-icing salt.

As a rule, only the upper layers of a traffic area are implemented in the form of a semi-rigid coating since, above all, resistance against permanent deformation is to be hereby increased. For example, the coating shows hardly any rutting or point load indentations compared to asphalt. In conventional construction, the underlying support layers are mostly implemented as asphalt or cement-bound support layers.

The current prior art regarding semi-rigid coatings summarizes, for example, the “Merkblatt für die Herstellung von halbstaren Deckschichten” [Guidelines for the production of semi-rigid top layers] of the Forschungsgesellschaft für Straβen and Verkehrswesen e.V. [Research association for roads and transportation], 2010 edition, ISBN 978-3-941790-51-3. According to this, cement (according to DIN EN 197 or with general technical approval) together with very fine binder and/or silica fume is to be used as a binder in a mortar for semi-rigid coatings, having a maximum grain size of <0.25mm (DIN EN 12620). The specific requirements that are in place for the properties of fresh mortar and hardened mortar are listed in Table 1:

TABLE 1

| Material properties | Requirement | Examination procedure |
|---|---|---|
| Fluidity fresh | immediately ≦45 s | Efflux time DIN EN 445, |
| mortar: | after 60 min. ≦55 s | Section 4.3.1 |
| Volume change on | ≦0.5% | DIN 52450 |
| prism hardened | | |
| mortar | | |
| Compressive | after 24 h ≧40 N/mm² | DIN EN 196-1 |
| strength | after 3 d ≧65 N/mm² | |
| | after 28 d ≧100 N/mm² | |
| Bending tensile | after 24 h ≧5 N/mm² | DIN EN 196-1 |
| strength | after 3 d ≧10 N/mm² | |
| | after 28 d ≧12 N/mm² | |

The creation of semi-rigid coatings takes place by creating an asphalt with a high void content, usually 10 to 40%, in particular 20 to 35%, on a suitable substructure. The production should take place mechanically since a particularly even surface is required for filling with mortar. The asphalt thickness is usually 2 to 10 cm, preferably 4 to 6 cm.

The mortar is applied as a slurry, i.e. as a mixture of cement, a very fine component and, as required, filling material, with water but substantially without aggregates; for this purpose, the mortar slurry must have particularly high flowability. One problem is that the application can only take place when the asphalt is cooled to 30° C. or less. If the mortar slurry is applied at higher asphalt temperatures, then excessively fast hardening and/or an excessive reduction in flowability can occur. Both can entail an insufficient void fill. Since the temperature of the asphalt at the time of installation is significantly higher (temperatures of over 100° C. are possible), the required cooling time slows down the construction progress.

A further problem of constructing semi-rigid coatings with mortar slurries is the application on surfaces and roads with slopes. On sloping roads, only small areas can be filled and/or the mortar slurry must be drawn back steadily against the slope until stiffening occurs. Furthermore, insufficient sealing of, for example, edgings or drain inlets due to the low viscosity of the mortar over long installation periods leads to uncontrolled leakage of the mortar slurry from the support structure. The consequences are defects, reworking and thus extensions to the construction time.

It would therefore be desirable to have a mortar slurry which is able to be installed at temperatures above 30° C., for example, at temperatures of 55° C. or more. Furthermore, it would be ideal if the mortar slurry were able to be used for slopes and did not leak or leaked only in negligible quantities in the event of insufficient sealing.

Suggestions about how semi-rigid coatings can be improved have already been made. Thus WO 02/75052 A1 teaches to provide the coating with a reinforcement in order to improve the strength of the coating.

According to WO 2009/133094 A1, the coating should achieve the additional function of air purification by adding a photocatalyst such as titanium dioxide. When exposed to sunlight, titanium dioxide can catalytically split pollutants, above all nitrogen oxide. The mortar slurry in WO 2009/133094 A1 is to contain cement, a photocatalyst, liquefier, viscosity regulator and defoamer. The problems referred to above are not addressed in these documents.

Mortars for semi-rigid coatings are known from WO 2008/128120 A1 which are to contain 15-50% Portland cement, 5-50% sand, 0-40% calcium carbonate, 0-2% accelerator, 0.02-1% liquefier, 0.02-1% water retention agent or rheological agent, 0-0.8% defoamer and 1-10% dispersible polymer. These mixtures are said to be able to be installed already at 125° F., so approximately 52° C., cooling overnight is still recommended. A similar coating, which is to be able to be installed at 50° C., is described in JP H10-1345. Compared to mortar slurries, these mortars with aggregate have a much lower cement content; the problems occurring for mortar slurries with high temperatures are solved or at least reduced by dilution with aggregates. To this end, the achievable strengths are significantly lower and do not meet the requirements for semi-rigid coatings made from mortar slurries for Germany.

Surprisingly, it has now been found that a mortar slurry made from cement with very fine parts, which contains at least one plasticizer but is free from silica fume, can already be introduced at asphalt temperatures of 80° C. If a gelling agent is added to a mortar slurry, a latent thixotropic mortar slurry results which can be installed on sloped roads and does not flow out or flows out in negligible quantities from the support structure.

The object of finding a more temperature-resistant mortar slurry is therefore solved by a dry mortar which contains at least 62% by weight cement and a very fine component and is free from silica fume and which is mixed with water to form the mortar slurry, wherein at least one plasticizer is contained in the dry mortar or in the water or is added together with the water.

Above all, cements according to DIN EN 197 or similar standards are useful as the cement. Portland cement and Portland cement mixed with latent hydraulic and/or pozzolanic materials such as fly ash, ground granulated blast furnace slag and natural pozzolans are preferred. Particularly preferred cements have high grinding fineness and a selected particle size distribution with high strength development, in particular at least of strength class 42.5 R, preferably strength class 52.5 R or N. Particularly preferred cements are those of cement classes CEM I, CEM II/A-LL, CEM II/B-LL, CEM II/A-V, CEM II/B-V, CEM II/A-S, CEM II/B-S, in particular CEM II/A, CEM II/B, CEM III/A, CEM IV/A and CEM V/A with the exception of CEM II/A-D. According to the invention, at least 62% by weight cement, preferred at least 88% by weight cement is contained. The cement content can be up to 99.5%, preferably up to 94% by weight. Especially between 88 and 94% by weight cement is contained.

As is known per se, the dry mortar contains a very fine component, preferably a very fine cement such as, for example, the very fine proportions of the component cement, but no silica fume. It was found according to the invention that, without the silica fume content, the problems which result when the mortar slurry is installed at asphalt temperatures above 30° C. can be avoided when the mortar slurry contains a plasticizer. Such knowledge cannot be found in the prior art. WO 02/075052 A1 recommends mortar slurries with silica fume. In WO 2009/133094 A1, in spite of the remark that silica fume is not required, an installation of mortar slurry is described only after 24 h cooling time. It was in no way to be expected or assumed that a mortar slurry, which is able to be processed and installed at 55 to 80° C. without problems and which is able to completely fill the void content of the asphalt support structure with no gaps, is obtained in the event of at least one plasticizer being present by excluding silica fume. Within the scope of the invention, silica fume means silica fume according to DIN EN 13263.

The dry mortar can furthermore contain inert, inorganic fillers such as limestone powder and/or other minerals or mineral mixtures. These are usually used in quantities in the range from 0.1 to 35% by weight based on the dry mass of the mortar slurry, in particular from 3 to 10% by weight. However, essentially no aggregates such as sand are contained.

Plasticising admixtures are contained in the mortar slurry, in particular in the dry mortar. Suitable are those, for example, based on lignosulphonates, melamine resins, (poly)naphthalene sulphonates and/or substances or substance mixtures referred to as polycarboxylate ethers (PCE), acrylic-based substances or substance mixtures, vinyl-based substances or substance mixtures, carboxylic acid-based substances or substance mixtures, as well as derivatives and/or a mixture of these. The plasticising admixture(s) are preferably used in quantities in the range from 0.5 to 5% by weight based on the dry mass of the mortar slurry, in particular from 0.6 to 1% by weight.

Organic and/or inorganic retarders such as, for example, fruit acids, preferably gluconates, and phosphates can be used in the mortar slurry. As a rule, these are used in quantities in the range from 0.01 to 2% by weight based on the dry mass of the mortar slurry, in particular from 0.01 to 0.05% by weight.

Furthermore, commercially available colour pigments can be contained for coloured design of the mortars, for example, for brightly coloured mortars, pigments based on iron oxide and for black mortars, pigments based on iron oxide and/or carbon (carbon black). If pigments are used, they are used in the known, conventional quantities.

Other known admixtures and/or additives can be contained, which is, however, not conventional and not preferable.

The dry mortar is typically mixed to create the mortar slurry in a ratio of dry substance:water in the range from 1:0.26 to 1:0.36, preferably in the range from 1:0.28 to 1:0.31.

The dry substance of the mortar slurry is normally and preferably a ready-made mixture which only has to be mixed with water for application. Individual components can also be added separately or as a component mixture during or shortly before mixing with water, for example, liquid admixtures, pigments etc. However, a ready-made dry mixture has several advantages: it reduces possible errors in dosage and can be mixed in the cement plant with greater accuracy than at the construction site. The degree of homogenisation is also improved by premixing in the plant. According to the invention, apart from water, preferably only dry components are used which are preferably prepared as a ready-made dry mixture.

A mortar slurry according to the invention can be introduced into the asphalt support structure at temperatures of 55° C. to a maximum of 80° C., so without or after a short cooling period, and fills the voids completely. Surprisingly, this does not lead to premature solidification/hardening or a relevant reduction in flowability.

Furthermore, it is possible to optimise the flow properties of the mortar slurry by adding gelling agents. The second object referred to above is therefore solved by a dry mortar comprising cement, a very fine component and a gelling agent, selected from clay, hydrophilic silica, highly dispersed silica, biopolymers and mixtures of two or more thereof.

A quantity of gelling agent in the range from 0.001 to 1% by weight based on the dry mass of the mortar slurry, in particular from 0.005 to 0.25% by weight, is thereby sufficient for obtaining a thixotropic mortar slurry. This stops flowing very quickly after filling, such that it does not flow off or flows off in negligible quantities on sloped roads and in the event of a “leaking” support structure. By supplying shear energy, for example by stirring, it can be attenuated again at any time until solidification/hardening. This makes it ideally suited to be installed on sloped roads, even in large sections in one go.

The remaining components of the mortar slurry can advantageously be selected as described above, such that this is not only thixotropic but is also able to be installed at higher temperatures. For the variants of the thixotropic mortar slurry, processing of 55° C. up to a maximum temperature of 60° C. is possible. Although that is lower than the mortar slurry according to the invention which is temperature stable but not thixotropic, it is considerably higher than for previous conventional mortar slurries. It should thereby be taken into account that cooling the freshly introduced asphalt is not linear, but rather slows down with a decreasing temperature difference between the asphalt support structure and the environment. Therefore, the thixotropic mortar slurry can be installed already after a cooling period which is considerably shorter compared to the prior art.

Preferred gelling agents are clay, for example bentonite, pyrogenic silica with a hydrophilic surface and biopolymers, in particular starch and polysaccharides, as well as mixtures of at least two thereof.

Particularly preferable compositions for mortar slurries are listed in Table 2.

TABLE 2

| | Proportion | Preferred proportion |
|---|---|---|
| Dry substance | [% by weight] | [% by weight] |
| Cement | 62-99.5 | 88-94 |
| Additives | 0-35 | 3-10 |
| Plasticising admixtures | 0.5-5 | 0.6-1 |
| Retarding admixtures | 0.01-2 | 0.01-0.05 |
| Gelling agent | 0.001-1 | 0.005-0.25 |

According to the invention, semi-rigid coatings can be created on support layers by an asphalt support structure with a high void content in the range from 10 to 40% by volume firstly being applied to this. A mortar slurry is then provided by a dry mortar according to the invention being mixed with water. The required or desired components are preferably dry except for the water and are preferably contained in the dry mortar. One or more components can also be added during mixing with water together with this or before, at the same time or afterwards. The obtained mortar slurry according to the invention can already be applied to the asphalt support structure from a temperature of the asphalt support structure of 80° C., or 60° C. with a gelling agent content, and then fills the void content completely. If gelling agents are contained, a large-scale installation can take place on sloped roads without time-consuming reworking.

The invention is to be illustrated with the aid of the following examples, without, however, being limited to the specifically described embodiments. Insofar as nothing else is specified or occurs in a necessarily different manner depending on context, percentage values relate to the weight, and, in case of doubt, the total weight of the mixture.

The invention also relates to all combinations of preferred embodiments, insofar as these are not mutually exclusive. The specifications “approximately” or “approx.” in connection with a numerical figure mean that values that are higher or lower by 10%, values that are higher or lower by 5% and in each case values that are higher or lower by 1%, are included.

### EXAMPLES

For the examples, the following substances were used:
Cement: CEM I 52.5 R
Mineral: inert mineral filler from the substance group alkaline earth carbonates, density ≧2.60g/cm³, particle size ≦0.1 mm
Plasticizer A: modified polycarboxylate ether
Plasticizer B: modified polycarboxylate ether
Gelling agent A: Clays with the main minerals: Kaolinite, illite, montmorillonite
Gelling agent B: Biopolymers
Gelling agent C: Hydrophilic pyrogenic silica
Retarder: phosphate/sucrose mixture
Mortar slurries are produced from the components specified in Tables 3 and 4 in the stated quantities in % by weight based on the dry substance with the addition of water at the specified ratio. The properties of the fresh mortar and the hardened mortar were respectively determined according to the method already stated above and are specified in Tables 5 and 6.

Furthermore, the efflux tendency of the mortar slurries is determined by means of a specifically developed device and method. The device is a container, for example a box, divided into two chambers. An asphalt support structure is installed in one region of the container, said support structure preferably corresponding to that which is to be filled with the mortar slurry to be tested. The chambers are divided at the start of the test with a slide and a seal on the asphalt side. At least such a quantity of mortar slurry, that is enough to fill the asphalt support structure, is added to the chamber prepared with asphalt. After a selected time period has passed, for example one hour, the slide is pulled up and the seal is removed. It is visually evaluated how far the mortar slurry flows out from the asphalt support structure if no additional shear energy is supplied to the system. The results are recorded in Table 5. The indication “yes” for retention means that no significant quantity of slurry flowed out, “no” means the flowing out of a larger quantity, which makes refilling voids necessary.

TABLE 3
Compositions of temperature-stable mortar slurry

| | MS 1 | MS 2 | MS 3 | MS 4 | MS 5 | MS 6 |
|---|---|---|---|---|---|---|
| Cement | 99.25 | 99.25 | 99.0 | 99.0 | 99.23 | 89.25 |
| Mineral | — | — | — | — | — | 10 |
| Plasticizer A | 0.75 | 0.75 | — | 1.0 | 0.75 | 0.75 |
| Plasticizer B | | | 1.0 | — | — | — |
| Retarder | — | — | — | — | 0.02 | — |
| Dry substance: | 1:0.29 | 1:0.31 | 1:0.29 | 1:0.29 | 1:0.30 | 1:0.29 |
| Water | | | | | | |

TABLE 4
Compositions of thixotropic mortar slurry

| | MS 7 | MS 8 | MS 9 |
|---|---|---|---|
| Cement | 89.00 | 88.85 | 89.24 |
| Mineral | 10.00 | 10.00 | 10.00 |
| Plasticizer A | 0.65 | 0.65 | 0.75 |
| Gelling agent A | 0.35 | — | — |
| Gelling agent B | — | 0.50 | |
| Gelling agent C | — | — | 0.01 |
| Dry substance:Water | 1:0.30 | 1:0.29 | 1:0.30 |

TABLE 5
Test results temperature-stable mortar slurry

| Property | Time | MS 1 | MS 2 | MS 3 | MS 4 | MS 5 | MS 6 |
|---|---|---|---|---|---|---|---|
| Efflux time | after | 20 s | 19 s | 27 s | 30 s | 16 s | 22 s |
| | mixing | | | | | | |
| | after 1 h | 48 s | 37 s | 42 s | 53 s | 33 s | 52 s |
| Compressive | 24 h | 97.2 | 56.8 | 57.7 | 53.3 | 83.0 | 59.1 |
| strength in | 3 d | 104.7 | 78.2 | 78.6 | 74.9 | 82.2 | 73.8. |
| N/mm² | 28 d | 143.8 | 106.9 | 104.6 | 103.4 | 101.9 | 102.0 |
| Bending tensile | 24 h | >15 | 6.5 | 12.6 | 9.7 | 10.5 | 9.8 |
| strength in | 3 d | >15 | 11.2 | >15 | 14.3 | 11.7 | 13.0 |
| N/mm² | 28 d | >15 | 14.2 | >15 | <15 | 13.0 | 12.8 |

TABLE 6
Test results thixotropic mortar slurry

| Property | Time | | MS 7 | MS 8 | MS 9 |
|---|---|---|---|---|---|
| Efflux time | after mixing | | 42 s | 43 s | 40 s |
| | after 1 | h | 54 s | 44 s | 44 s |
| Compressive | 24 | h | 64.2 | 61.0 | 56.5 |
| strength | 3 | d | 84.1 | 76.9 | 68.8 |
| in N/mm² | 28 | d | 116.7 | 107.1 | 106.1 |
| Bending tensile | 24 | h | 7.1 | 10.4 | 7.3 |
| strength | 3 | d | 12.6 | 10.0 | 12.7 |
| in N/mm² | 28 | d | 13.2 | 13.4 | 14.1 |
| Retention | after 1 | h | yes | yes | yes |

It is clear from the measurement results in Tables 5 and 6 that the mortar slurries according to the invention solve the objects. The properties of the mortar slurries correspond to the requirements of the guidelines with respect to the processing properties of fresh mortar and the mechanical properties of hardened mortar.

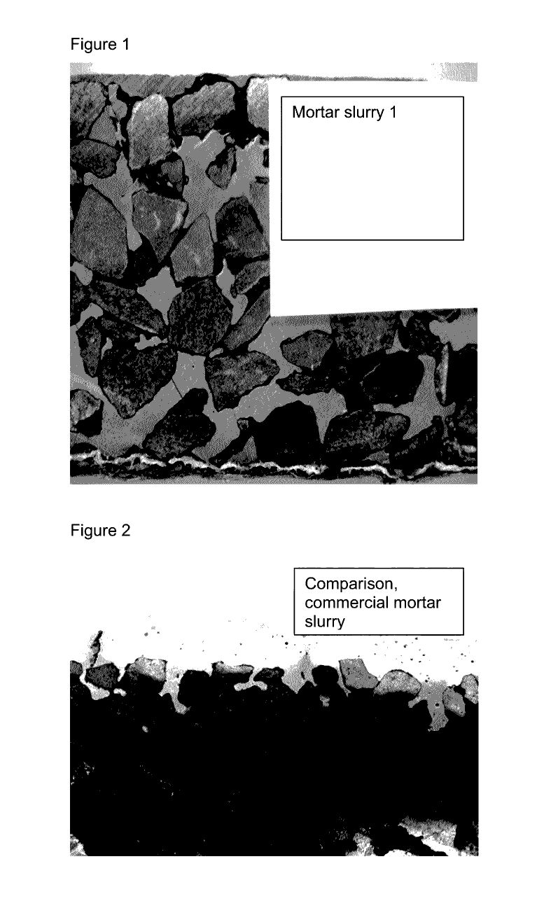

As was confirmed by means of sample cross sections, the temperature-stable mortar slurry fills the voids reliably and completely even with 80° C. hot asphalt. In FIG. 1, a cross section is shown for the mortar slurry 1 introduced at 80° C. asphalt temperature. In comparison, FIG. 2 shows the result when using a mortar slurry made from a commercially obtainable dry mortar containing silica fume. It is clear to see that the comparison mortar slurry applied at 80° C. can barely enter the asphalt support structure; useful coatings are therefore not obtained.

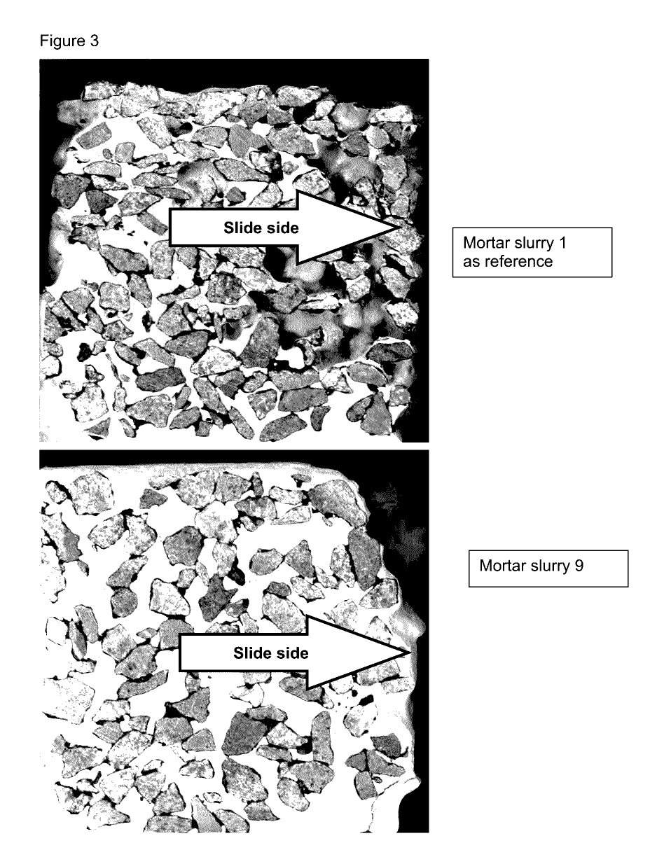

The thixotropic mortar slurry can also fill the voids reliably and completely at 60° C. and lower. It thereby shows a highly reduced flow after just a short time. In FIG. 3, the results of the described, newly developed method for the mortar slurry 1 as reference and mortar slurry 9 are shown. It is good to recognise that the mortar slurry 1 without gelling agent flows out of the support structure over a large area, whereas no flowing out is apparent for the mortar slurry 9 with gelling agent.

The semi-rigid coatings described are suitable for cover layers on particularly stressed traffic areas such as, for example, support surfaces for heavy goods vehicles, bus traffic areas, areas before signalling systems, industrial spaces such as, for example, container terminals, harbours/docks, airfields and warehouse floors. The system can also be used in the scope of refuelling systems and for storage, filling and handling areas for water-polluting substances. The system is applied to a base made from asphalt or a hydraulically bound support layer. It can be used in new constructions and in renovations or strengthening of buildings. A significant amount of time can thereby be saved during installation. For the thixotropic mortar slurries, there is a higher fault tolerance regarding “leaking” asphalt support structures and a facilitated and quicker installation for sloped roads. It also seems to be possible to provide roads having a larger slope than before with the semi-rigid coating.

1-15. (canceled)

16. Dry mortar comprising cement and a very fine component which is able to be mixed to form a mortar slurry, wherein no silica fume is contained and the dry mortar contains at least one plasticizer and/or at least one plasticizer is contained in the water or is added during mixing with water, wherein at least 62% by weight cement is contained and the compressive strength of the mortar slurry is at least 100 N/mm² after 28 days.

17. Dry mortar according to claim 16, wherein at least 88% by weight cement is contained.

18. Dry mortar according to claim 16, wherein no aggregate is contained.

19. Dry mortar according to claim 16, wherein a gelling agent is contained.

20. Dry mortar according to claim 19, wherein the gelling agent is selected from the group consisting of clay, pyrogenic silica, highly dispersed silica, biopolymers and mixtures of two or more of these.

21. Dry mortar according to claim 19, wherein the gelling agent is contained in a quantity in the range from 0.001 to 1% by weight based on a dry substance of the dry mortar.

22. Dry mortar according to claim 16, wherein the dry mortar contains one or more plasticising admixtures.

23. Dry mortar according to claim 16, wherein the plasticising admixture/admixtures is/are contained in a quantity in the range from 0.5 to 5% by weight based on a dry substance of the mortar.

24. Dry mortar according to claim 16, wherein the cement is selected from the group consisting of Portland cement and Portland cement mixed with latent hydraulic and/or pozzolanic materials.

25. Dry mortar according to claim 16, wherein the dry mortar contains inert filling materials.

26. Dry mortar according to claim 16, wherein one or more retarder(s) is/are contained.

27. Mortar slurry obtainable by mixing a dry mortar with water, wherein the dry mortar comprises at least 62% by weight cement and a very fine component, wherein no silica fume is contained and wherein the dry mortar contains at least one plasticizer and/or at least one plasticizer is contained in the water or is added during mixing with water and wherein the compressive strength of the mortar slurry is at least 100 N/mm² after 28 days.

28. Mortar slurry according to claim 27, wherein only the dry mortar and water are contained.

29. Method for producing a semi-rigid coating on a support layer, comprising the steps
applying an asphalt support structure with a void content in the range from 10 to 40% by volume preparing a mortar slurry from a dry mortar comprising 62 to 99.5% by weight cement and a very fine component by mixing the dry mortar with water to form the mortar slurry, wherein no silica fume is contained in the mortar slurry and the dry mortar contains at least one plasticizer and/or at least one plasticizer is contained in the water or is added with the water, wherein
the mortar slurry is applied at a temperature of the asphalt support structure of 55 to 80° C.

30. Method for producing a semi-rigid coating on a sloping support layer, comprising the steps
applying an asphalt support structure with a void content in the range from 10 to 40% by volume preparing a mortar slurry from a dry mortar comprising 62 to 99.5% by weight cement, a very fine component and a gelling agent by mixing the dry mortar with water to form the mortar slurry, wherein no silica fume is contained in the mortar slurry and the dry mortar contains at least one plasticizer and/or at least one plasticizer is contained in the water or is added with the water,
and applying the mortar slurry at a temperature of the asphalt support structure of 55 to 60° C.

31. Dry mortar according to claim 20, wherein the gelling agent is contained in a quantity in the range from 0.005 to 0.25% by weight based on a dry substance of the dry mortar.

32. Dry mortar according to claim 22, wherein the plasticising admixture(s) is(are) selected from the group consisting of plasticizers based on lignosulphonates, melamine resins, (poly)naphthalene sulphonates, substances or substance mixtures referred to as polycarboxylate ethers (PCE), acrylic-based substances or substance mixtures, vinyl-based substances or substance mixtures, carboxylic acid-based substances or substance mixtures as well as their derivatives, and mixtures of two or more thereof.

33. Dry mortar according to claim 32, wherein the plasticising admixture(s) is(are) contained in a quantity in the range from 0.6 to 1% by weight.

34. Dry mortar according to claim 25, wherein the inert filling material is limestone powder.

35. Dry mortar according to claim 26, wherein the one or more retarder(s) is(are) gluconates and/or phosphate/sucrose.

36. Dry mortar according to claim 35, wherein at least 88% by weight cement is contained.

37. Dry mortar according to claim 33, wherein an inert filling material being limestone powder is contained.

38. Mortar slurry according to claim 27, wherein the plasticising admixture(s) is(are) selected from the group consisting of plasticizers based on lignosulphonates, melamine resins, (poly)naphthalene sulphonates, substances or substance mixtures referred to as polycarboxylate ethers (PCE), acrylic-based substances or substance mixtures, vinyl-based substances or substance mixtures, carboxylic acid-based substances or substance mixtures as well as their derivatives, and mixtures of two or more thereof.

39. Mortar slurry according to claim 38, wherein at least 88% by weight cement is contained.

40. Mortar slurry according to claim 38, wherein an inert filling material being limestone powder is contained.

41. Mortar slurry according to claim 28, wherein the plasticising admixture(s) is(are) selected from the group consisting of plasticizers based on lignosulphonates, melamine resins, (poly)naphthalene sulphonates, substances or substance mixtures referred to as polycarboxylate ethers (PCE), acrylic-based substances or substance mixtures, vinyl-based substances or substance mixtures, carboxylic acid-based substances or substance mixtures as well as their derivatives, and mixtures of two or more thereof.

42. Mortar slurry according to claim 41, wherein at least 88% by weight cement is contained.
